(19) United States
(12) Patent Application Publication
(10) Pub. No.: US 2008/0124472 A1
(43) Pub. Date: May 29, 2008

(54) Clearcoating composition with unblocked acid catalyst

(76) Inventors: David K. Lau, Royal Oak, MI (US); Donald H. Campbell, Hartland Township, MI (US); Gregory G. Menovcik, Northville, MI (US)

Correspondence Address: BASF CORPORATION;Patent Department, 1609 BIDDLE AVENUE, MAIN BUILDING, WYANDOTTE, MI, 48192, US

(21) Appl. No.: 11/998,295

(22) Filed: Nov. 29, 2007

Related U.S. Application Data
(60) Provisional application No. 60/867,591, filed on Nov. 29, 2006.

(51) Int. Cl. B05D 3/00

(52) U.S. Cl. 427/385.5

(57) ABSTRACT

A two-component solvent-borne clearcoat composition comprising an unblocked acid catalyst, a film-forming binder, and an aminoplast crosslinking agent (e.g., a melamine formaldehyde crosslinking agent) surprisingly provides enhanced appearance when compared to a one-component clearcoating composition containing blocked acid catalyst cured at temperatures above 121° C. (250° F.).

### CROSS-REFERENCE TO RELATED APPLICATIONS

This application claims the benefit of U.S. Provisional Application No. 60/867,591, filed on Nov. 29, 2006.

### FIELD OF THE INVENTION

The present invention relates to thermosetting coating compositions, particularly thermosetting clearcoat coating compositions.

### BACKGROUND OF THE INVENTION

The statements in this section merely provide background information related to the present disclosure and may not constitute prior art.

In clearcoat compositions it is desired that clearcoats with low volatile organic content give good appearance and camouflage any unevenness in the basecoat to provide a smooth appearance. It is also important that the coating provide sag resistance and good overall appearance.

It is known in the art to utilize melamine crosslinkers catalyzed with acid catalyst to cure a clearcoating composition. Typically a weak acid such as a polymer-bound acid is used to catalyze cure of high imino content melamine crosslinkers. These coating compositions containing high imino content may be one-component coatings, where the melamine crosslinker and principal coating resin are present in one composition and the acid component is not blocked. Melamine crosslinkers with low imino content may also be used in a one-component coating composition and generally require a stronger acid catalyst to achieve adequate cure. The stronger acid must be blocked, for example with an amine blocking agent, to provide a storage-stable coating in a one-component coating. Generally, the one-component coating compositions described herein are cured at elevated temperatures, usually in excess of 250° F. (121° C.), to achieve the properties desired in a crosslinked film.

Two-component coatings may contain an unblocked acid catalyst and can be mixed and cured at temperatures below 250° F., for example for low-bake repair. Such coating compositions require that the acid and the melamine components be kept separate to prevent reaction of the melamine catalyzed by the acid catalyst. Once the components are combined they are typically usable for from 1 to 8 hours before viscosity increase due to reaction between the melamine and principal resin that renders the paint unsprayable. These clearcoat compositions are generally cured at temperatures of less than 250° F. (121° C.), for from 10-40 minutes.

### SUMMARY OF THE INVENTION

The present invention provides a two-component solvent-borne clearcoat composition comprising an unblocked acid catalyst, a film-forming binder, and an aminoplast crosslinking agent. The aminoplast crosslinking agent may be a melamine formaldehyde crosslinking agent. The use of the unblocked acid catalyst together with a aminoplast crosslinker surprisingly provides enhanced appearance when compared to a one-component clearcoating composition containing blocked acid catalyst, cured at temperatures above 250° F. (121° C.). The clearcoat provides resistance to scratching and environmental etch and good weathering durability. The coating is compatible with waterborne, solventborne and powder basecoat compositions.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

As used throughout, ranges are used as shorthand for describing each and every value that is within the range. Any value within the range can be selected as the terminus of the range. When used, the phrase “at least one of” refers to the selection of any one member individually or any combination of the members. “A” is used to mean one or more. The conjunction “and” or “or” can be used in the list of members, but the “at least one of” phrase is the controlling language. For example, at least one of A, B, and C is shorthand for A alone, B alone, C alone, A and B, B and C, A and C, or A and B and C.

As used herein, the term “clearcoat” refers to a generally transparent coating layer which is positioned over a basecoat or color coat layer. Furthermore, the clearcoat is generally the outermost coating over the substrate. Thus the outer surface of the clearcoat is directly exposed to the environment.

As a general rule, the clearcoat is substantially transparent, whereby the basecoat is visible through the clearcoat. However, the clearcoat may comprise pigments, dyes, etc, in order to obtain coloration effects in combination with the basecoat. Even if the clearcoat comprises pigments, the clearcoat is still considered to be substantially transparent if the pigments are transparent pigments or if an effect pigment (particularly flake pigments) is included in an amount that is less than the minimum amount required for hiding. However, generally the clearcoat is not colored and is thus substantially transparent as well as substantially colorless. The clearcoat preferably comprises primarily a polymer network (i.e. a crosslinked polymer) which is highly resistant to environmental degradation from ultraviolet light, water, high and low temperature extremes, dust and dirt, etc.

The phrase “solvent-borne clearcoat composition” refers to a substantially liquid composition (i.e. a suspension or solution of a polymer, together with other ingredients in an organic solvent) which, in the process of the present invention, is to be applied over an uncured layer of the basecoat composition and which, when cured, forms the clearcoat.

The coating composition is a solvent-borne, two-component clearcoat composition comprising a film-forming binder, an aminoplast (e.g., melamine-formaldehyde resin) crosslinking agent reactive with the binder and an unblocked acid catalyst. A “two-component” composition is one in which the materials of the composition are kept in two separate components or packages (also called packs) until shortly before application, when the two components or packages are combined and applied as a clearcoat composition. The two components or packages of the solvent-borne, two-component clearcoat composition separate the film forming binder, aminoplast resin, and unblocked acid catalyst so that only two of the three are in one of the components and the remaining one of the three is in the other component. It is not critical whether it is the film forming binder, the aminoplast crosslinking agent, or the unblocked acid catalyst that is segregated from the other two materials. In one embodiment the film forming binder and the aminoplast crosslinking agent are in separate components, and the unblocked acid catalyst combined in either or both of the film forming binder and the aminoplast crosslinking agent components. The unblocked acid is preferably added to the component containing the film forming binder.

The coating composition may comprise as a film-forming binder a polymeric or oligomeric compound which will generally have a number average molecular weight of from 500 to 1,000,000, more preferably from 600 to 10,000 and the compound will generally have an equivalent weight of from 114 to 2000, and more preferably 250 to 750.

Such polymeric or oligomeric compounds may be present in the coating composition in amounts of from more than 0 and up to 90%, preferably from 1 to 80%, and most preferably from 50 to 80%, all based on the fixed vehicle solids of the coating composition, i.e., wt. % nonvolatile components.

The film-forming binder may comprise one or more polyfunctional oligomeric or polymeric compounds. The polymeric compounds will comprise one or more active hydrogen groups. “Active hydrogen group” as used herein refers to functional groups which donate a hydrogen group during the reaction with the functional groups of compounds (a). Examples of active hydrogen groups are carbamate groups, hydroxyl groups, amino groups, thiol groups, acid groups, hydrazine groups, activated methylene groups, and the like. Preferred active hydrogen groups are carbamate groups, hydroxyl groups, and mixtures thereof.

Such active hydrogen group containing binders include, for example, acrylic polymers, modified acrylic polymers, polyesters, polyepoxides, polycarbonates, polyurethanes, polyamides, polyimides, and polysiloxanes, star ester oligomers and urethane oligomers and dimer-fatty carbamate compounds as described below, all of which are well-known in the art. The preferred binders are star ester oligomers, urethane oligomers and dimer-fatty carbamate compounds.

The film-forming binder may comprise a dimer-fatty carbamate composition comprising (i) from 12 to 72 carbon atoms, and (ii) at least two functional groups, and comprises a mixture of two or more structures substantially without heteroatoms selected from the group consisting of aliphatic structures, aromatic-containing structures, cycloaliphatic-containing structures, and mixtures thereof, wherein at least one of the two or more structures is either a cycloaliphatic-containing structure or an aromatic-containing structure. More preferably the dimer-fatty carbamate composition comprises from 18 to 54 carbons, and most preferably from 36 to 54 carbons. In a particularly preferred embodiment of the invention, the dimer-fatty carbamate composition will have 36 carbons.

“Heteroatoms” as used herein refers to atoms other than carbon or hydrogen. The phrase “substantially without” heteroatoms as used herein means that the portion of dimer-fatty carbamate composition which does not include functional groups (ii) will generally have no more than two atoms which are other than carbon or hydrogen, i.e., atoms such as N, O, Si, mixtures thereof, and the like. More preferably, that portion of the dimer-fatty carbamate composition that does not include functional groups will have no more than one atom that is other than carbon or hydrogen. In a most preferred embodiment, that portion of the dimer-fatty carbamate composition that does not include functional groups will have no heteroatoms, i.e., will consist solely of carbon and hydrogen atoms. It is another aspect of the invention that the dimer-fatty carbamate composition will not be a crystalline solid at room temperature, i.e., at temperatures of from 65 to 75° F. “Crystalline” refers to a solid characterized by a regular, ordered arrangement of particles. Rather, the reactive component will be an amorphous solid, a wax or a liquid at room temperature. “Amorphous” refers to a noncrystalline solid with no well-defined ordered structure.

In one preferred embodiment of the invention, the dimer-fatty carbamate composition will comprise a mixture of two or more saturated or unsaturated structures selected from the group consisting of non-cyclic structures for reactive component (a), aromatic-containing structures for reactive component (a), cyclic-containing structures for reactive component (a), and mixtures thereof. Saturated structures are preferred, especially where durability issues are of concern. For example, a most preferred reactive component (a) will comprise a mixture of two or more structures selected from the group consisting of aliphatic structures for reactive component (a), aromatic-containing structures for reactive component (a), cycloaliphatic-containing structures for reactive component (a), and mixtures thereof.

It is particularly preferred that the dimer-fatty carbamate composition comprise at least two, more preferably three, of the three cited structures. If the dimer-fatty carbamate composition comprises only two of the three cited structures for the dimer-fatty carbamate composition, then at least one of the two structures must be present as a mixture of two or more isomers thereof.

For example, the mixture of the dimer-fatty carbamate compositions structures may comprise at least one aliphatic structure for the dimer-fatty carbamate composition and at least one other structure for the dimer-fatty carbamate composition selected from the group consisting of aromatic-containing structures, cycloaliphatic-containing structures, and mixtures thereof. If the “at least one other structure” is not a mixture of aromatic-containing structures and cycloaliphatic-containing structures, either the aromatic-containing structures or the cycloaliphatic containing structures must be present as a mixture of two or more isomers.

Alternatively, the mixture of structures of the dimer-fatty carbamate composition may comprise at least one aromatic-containing structure and at least one other structure selected from the group consisting of aliphatic structure, cycloaliphatic-containing structures, and mixtures thereof. If the at least one other structure is not a mixture of aliphatic structures and cycloaliphatic-containing structures, either the aliphatic structures or the cycloaliphatic containing structures must be present as a mixture of two or more isomers.

In one embodiment, the dimer-fatty carbamate composition will comprise one or more aliphatic structures, one or more aromatic-containing structures, and one or more cycloaliphatic-containing structures. Particularly advantageous mixtures of structures in the dimer-fatty carbamate composition will comprise from 3 to 25% by weight of the dimer-fatty carbamate composition having an aliphatic structure, from 3 to 25% by weight of r the dimer-fatty carbamate composition having an aromatic-containing structure, and 50 to 94% by weight of the dimer-fatty carbamate composition having a cycloaliphatic-containing structure. Alternatively, mixtures of the dimer-fatty carbamate composition will comprise from 3 to 18% by weight of the dimer-fatty carbamate composition having an aliphatic structure, from 5 to 23% by weight of the dimer-fatty carbamate composition having an aromatic-containing structure, and 55 to 85% by weight of the dimer-fatty carbamate composition having a cycloaliphatic-containing structure. Alternatively, mixtures of the dimer-fatty carbamate composition will comprise from 5 to 10% by weight of the dimer-fatty carbamate composition having an aliphatic structure, from 10 to 20% by weight of the dimer-fatty carbamate composition having an aromatic-containing structure, and 60 to 70% by weight of the dimer-fatty carbamate composition having a cycloaliphatic-containing structure.

Finally, the dimer-fatty carbamate composition must comprise at least two functional groups (ii). Preferred dimer-fatty carbamate compositions may have from two to six functional groups (ii) while most preferably the dimer-fatty carbamate composition will have two to three functional groups (ii).

Functional groups (ii) may be selected from a wide variety of active hydrogen containing groups and groups reactive with such active hydrogen containing groups. While active hydrogen containing groups are preferred, functional group (ii) may be any one of a pair of reactants which would result in a thermally irreversible chemical linkage such as is described above, i.e., urethane, urea, ester, and ether.

Thus, illustrative functional groups (ii) may be selected from the group consisting of hydroxyl, urea, carbamate, cyclic carbonate, and mixtures thereof. Preferred functional groups (ii) are hydroxyl, primary carbamate functional groups, and mixtures thereof. Most preferred functional groups (ii) are hydroxyl, primary carbamate, and mixtures thereof.

Hydroxyl functional reactive components (a) are commercially available as the Pripol™ saturated fatty acid dimer (Pripol™ 2033) supplied by Uniqema of Wilmington, Del. Hydroxyl functional dimer-fatty carbamate compositions may also be obtained by reduction of the acid group of the above discussed fatty acids.

The dimer-fatty carbamate composition having two or more carbamate functional groups may be obtained via the reaction of the hydroxyl functional dimer-fatty carbamate compositions with a low molecular weight carbamate functional monomer such as methyl carbamate under appropriate reaction conditions. Alternatively, carbamate functional dimer-fatty carbamate compositions may be made via decomposition of urea in the presence of hydroxyl functional dimer-fatty carbamate compositions as described above. Finally, carbamate functional dimer-fatty carbamate compositions can be obtained via the reaction of phosgene with the hydroxyl functional dimer-fatty carbamate compositions followed by reaction with ammonia.

Dimer-fatty carbamate compositions having urea functional groups (ii) may be made via reaction of an amine functional dimer-fatty carbamate composition with urea. Alternatively, amine functional dimer-fatty carbamate composition can be reacted with phosgene followed by reaction with ammonia to produce the desired urea functional groups (ii).

Dimer-fatty carbamate compositions having cyclic carbonate functional groups (ii) may be made via carbon dioxide insertion into an epoxy functional dimer-fatty carbamate composition as described above.

In addition to carbamate functional dimer-fatty carbamate compositions, other carbamate functional materials useful for the film-forming binder in the composition of the invention can be prepared in a variety of ways. One way to prepare carbamate functional polymer is to polymerize an acrylic monomer having carbamate functionality in the ester portion of the monomer. Such monomers are well known in the art and are described, for example in U.S. Pat. Nos. 3,479,328, 3,674,838, 4,126,747, 4,279,833, and 4,340,497, 5,356,669, and WO 94/10211, the disclosures of which are incorporated herein by reference. One method of synthesis involves reaction of a hydroxy ester with urea to form the carbamoyloxy carboxylate (i.e., carbamate-modified acrylic). Another method of synthesis reacts an α,β-unsaturated acid ester with a hydroxy carbamate ester to form the carbamoyloxy carboxylate. Yet another technique involves formation of a hydroxyalkyl carbamate by reacting a primary or secondary amine or diamine with a cyclic carbonate such as ethylene carbonate. The hydroxyl group on the hydroxyalkyl carbamate is then esterified by reaction with acrylic or methacrylic acid to form the monomer. Other methods of preparing carbamate-modified acrylic monomers are described in the art, and can be utilized as well. The acrylic monomer can then be polymerized along with other ethylenically unsaturated monomers, if desired, by techniques well known in the art.

An alternative route for preparing carbamate compounds useful for the film-forming binder in the composition of the invention is to react an already-formed polymer such as an acrylic polymer with another component to form a carbamate-functional group appended to the polymer backbone, as described in U.S. Pat. No. 4,758,632, the disclosure of which is incorporated herein by reference. One technique for preparing such polymers involves thermally decomposing urea (to give off ammonia and HNCO) in the presence of a hydroxy-functional acrylic polymer to form a carbamate-functional acrylic polymer. Another technique involves reacting the hydroxyl group of a hydroxyalkyl carbamate with the isocyanate group of an isocyanate-functional acrylic or vinyl monomer to form the carbamate-functional acrylic. Isocyanate-functional acrylics are known in the art and are described, for example in U.S. Pat. No. 4,301,257, the disclosure of which is incorporated herein by reference. Isocyanate vinyl monomers are well known in the art and include unsaturated m-tetramethyl xylene isocyanate (sold by American Cyanamid as TMI®). Yet another technique is to react the cyclic carbonate group on a cyclic carbonate-functional acrylic with ammonia in order to form the carbamate-functional acrylic. Cyclic carbonate-functional acrylic polymers are known in the art and are described, for example, in U.S. Pat. No. 2,979,514, the disclosure of which is incorporated herein by reference. Another technique is to transcarbamylate a hydroxy-functional acrylic polymer with an alkyl carbamate. A more difficult, but feasible way of preparing the polymer would be to trans-esterify an acrylate polymer with a hydroxyalkyl carbamate.

The polymeric or oligomer carbamate compound will generally have a molecular weight of 2000-20,000, and preferably from 3000-6000. As used herein, molecular weight means number average molecular weight, and can be determined by the GPC method using a polystyrene standard. The carbamate content of the film-forming binder, on a molecular weight per equivalent of carbamate functionality, will generally be between 200 and 1500, and preferably between 300 and 500. The glass transition temperature, T_{g}, of the binder components can be adjusted to achieve a cured coating having the T_{g} for the particular application involved.

In one embodiment of the invention, carbamate functional compounds useful for the film-forming binder comprise monomeric polyisocyanate reacted with a compound containing an isocyanate-reactive group and a carbamate group, e.g., a hydroxyalkyl carbamate such as hydroxypropyl carbamate or hydroxyethyl carbamate. Alternatively, the polyisocyanate may be adducted with substituents that have the capability of forming carbamate groups after reaction with the polyisocyanate compound is completed. For example, the polyisocyanate can be reacted with a compound having an active hydrogen group (e.g., hydroxyl) and a cyclic carbonate group (e.g., the reaction product of glycidol and CO₂), and the cyclic carbonate groups then reacted with ammonia to form the carbamate functional groups. Alternatively, the polyisocyanate can be reacted with an active hydrogen group (e.g., hydroxyl) and an epoxy group, and then with CO₂ to convert the epoxy to cyclic carbonate, and the cyclic carbonate groups then reacted with ammonia to form the carbamate functional groups.

The monomeric polyisocyanate can be an aliphatic polyisocyanate, including a cycloaliphatic polyisocyanate or an aromatic polyisocyanate. Useful aliphatic polyisocyanates include aliphatic diisocyanates such as ethylene diisocyanate, 1,2-diisocyanatopropane, 1,3-diisocyanatopropane, 1,6-diisocyanatohexane, 1,4-butylene diisocyanate, lysine diisocyanate, 1,4-methylene bis-(cyclohexyl isocyanate) and isophorone diisocyanate. Useful aromatic diisocyanates and araliphatic diisocyanates include the various isomers of toluene diisocyanate, meta-xylylenediioscyanate and para-xylylenediisocyanate, also 4-chloro-1,3-phenylene diisocyanate, 1,5-tetrahydro-naphthalene diisocyanate, 4,4′-dibenzyl diisocyanate and 1,2,4-benzene triisocyanate can be used. In addition, the various isomers of α,α,α′,α′-tetramethyl xylylene diisocyanate can be used. Biurets of isocyanates such as DESMODUR® N100 from Bayer may also be useful.

Another method of synthesis is to first react the isocyanate groups on the polyisocyanate with a compound having a group that is reactive with isocyanate and also a non-NCO functional group. This adduct is then reacted with a compound comprising at least one carbamate group or group that can be converted to carbamate and at least one group reactive with the non-NCO functional groups. Examples of non-NCO functional groups include carboxyl, epoxy, hydroxyl, amino. For example, an OH-functional polyisocyanate (which can be formed by reacting a polyisocyanate with an amino alcohol) can be reacted with the oxygen of a COO portion of the carbamate group on an alkyl carbamate or with the methylol group of methylol acrylamide (HO—CH₂—NH—CO—CH═CH₂). In the case of the COO group on an alkyl carbamate, the hydroxyl group on the polyurethane undergoes a transesterification with the COO group, resulting in the carbamate group being appended to the polyurethane. In the case of methylol acrylamide, the unsaturated double bond is then reacted with peroxide, CO₂, and ammonia as described above. The epoxy groups are then reacted with CO₂ to form cyclic carbonate groups, which are converted to carbamate groups by reaction with ammonia. Alternatively, an acid-functional polyisocyanate (which can be formed by reaction of a polyisocyanate with a hydroxy-functional carboxylic acid) can be reacted with acetic anhydride to generate an anhydride-functional triisocyanurate, which can then be reacted with an hydroxycarbamate.

The above-described monomeric polyisocyanates are adducted with compounds containing a carbamate group or group that can be converted to carbamate and a group that is reactive with the NCO- or non-NCO-functional group on the polyisocyanate. Carbamate-containing compounds that can be adducted onto the NCO groups of a diisocyanate or an isocyanurate are preferably active hydrogen-containing carbamates such as hydroxyalkyl carbamates (e.g., hydroxypropyl carbamate or hydroxyethyl carbamate). Compounds containing groups that can be converted to carbamate and groups that are reactive with NCO include active hydrogen-containing cyclic carbonate compounds convertible to carbamate by reaction with ammonia (e.g., the reaction product of glycidol and CO₂), monoglycidyl ethers (e.g., Cardura E®) convertible to carbamate by reaction with CO₂ and then ammonia, and monoglycidyl esters (e.g., the reaction product of a carboxylic acid and epichlorohydrin) convertible to carbamate by reaction with CO₂ and then ammonia, allyl alcohols where the alcohol group is reactive with NCO and the double bond can be converted to carbamate by reaction with peroxide, and vinyl esters where the ester group is reactive with NCO and the vinyl group can be converted to carbamate by reaction with peroxide, then CO₂, and then ammonia. The above embodiments are described in U.S. Pat. No. 5,512,639.

Alternatively, star ester oligomers such as those described in U.S. Patent Publication 2004/0171748, which is hereby incorporated by reference may also be used as the film-forming binder. Generally, the ester oligomer is the reaction product of a first compound and a carboxylic acid anhydride. A plurality of the first compound and a plurality of the carboxylic acid anhydride are present. The first compound includes hydroxyl groups. More specifically, the plurality of the carboxylic acid anhydride is reacted with the hydroxyl groups of the first compounds. This reaction forms a plurality of first intermediate compounds that have at least one hydroxyl group and carboxylic acid groups.

Once the first intermediate compounds are formed, a temperature of these intermediate compounds is raised until the hydroxyl group of one first intermediate compound condenses with one of the carboxylic acid groups of another first intermediate compound. This condensing, or condensation, forms a polyester resin having an ester linkage and carboxylic acid groups. The polyester is derived from the ester linkage established between two first intermediate compounds. A second compound having at least one epoxy group and also a carbamate compound may be subsequently reacted with the polyester. A coating composition according to the present invention includes the polyester and also incorporates a cross-linking agent that is reactive with the polyester.

In one embodiment of the invention, the coating may also include acrylic polymer. The acrylic polymer preferably has a molecular weight of 500 to 1,000,000, and more preferably of 1500 to 50,000. As used herein, “molecular weight” refers to number average molecular weight, which may be determined by the GPC method using a polystyrene standard. Such polymers are well-known in the art, and can be prepared from monomers such as methyl acrylate, acrylic acid, methacrylic acid, methyl methacrylate, butyl methacrylate, cyclohexyl methacrylate, and the like. The active hydrogen functional group, e.g., hydroxyl, can be incorporated into the ester portion of the acrylic monomer. For example, hydroxy-functional acrylic monomers that can be used to form such polymers include hydroxyethyl acrylate, hydroxybutyl acrylate, hydroxybutyl methacrylate, hydroxypropyl acrylate, and the like. Amino-functional acrylic monomers would include t-butylaminoethyl methacrylate and t-butylamino-ethylacrylate. Other acrylic monomers having active hydrogen functional groups in the ester portion of the monomer are also within the skill of the art.

Modified acrylics can also be used. Such acrylics may be polyester-modified acrylics, epoxy modified acrylics or polyurethane-modified acrylics, as is well-known in the art. Polyester-modified acrylics modified with ε-caprolactone are described in U.S. Pat. No. 4,546,046 of Etzell et al, the disclosure of which is incorporated herein by reference. Polyurethane-modified acrylics are also well-known in the art. They are described, for example, in U.S. Pat. No. 4,584,354, the disclosure of which is incorporated herein by reference.

For the coating compositions of the invention, the binder component must be combined with an aminoplast crosslinking agent. The aminoplast crosslinking agent must have a plurality of functional groups which are reactive with the functional groups of the binder component. The aminoplast crosslinking agent will be used in amounts of from 1 to 90%, preferably from 3 to 50%, and more preferably from 15 to 35%, all based on the total fixed vehicle of the coating composition, i.e., the % nonvolatiles. The aminoplast crosslinking agent is preferably an alkylated monomeric melamine formaldehyde crosslinker. One example of such melamine crosslinkers includes a methylated monomeric melamine crosslinker. The aminoplast crosslinker may be a low imino or high imino content melamine. By imino content is meant the percentage of N—H groups as a percent of the total melamine groups. As used herein, low imino content means <10% N—H groups based on total melamine groups. As used herein, high imino content means >10% N—H groups based on total melamine groups.

In general, the unblocked acid catalyst used in the clearcoat of the present invention can be any chemical species which catalyzes the curing of monomeric melamine. Preferably, the acid catalyst comprises at least one member selected from the group consisting of an acid anhydride, an acid phosphate, a mono or disulfonic acid, an alkoxyacid, and any other acid catalyst suitable for the curing of monomeric melamine. Preferably, the acid catalyst comprises at least one member selected from the group consisting of a para-toluene sulfonic acid, a dodecylbenzene sulfonic acid, a dinonylnaphthalene disulfonic acid, a phenyl acid phosphate, a phenyl phosphonous acid and an alkyl acid phosphate. Most preferably the acid catalyst comprises at least one member selected from the group consisting of a phenyl acid phosphate or a phenyl phosphonous acid or alkyl acid phosphate. The selection of the particular acid catalyst (or combination of acid catalysts) may include at least one acid catalyst such as phenyl acid phosphate, alkyl acid phosphate, such as butyl acid phosphate, phenyl phosphonous acid and sulfonic acid. The acid catalysts having a pKa of <3.5 are particularly effective in the present invention.

In general, during the process of the present invention, the acid catalyst is present in the solventborne clearcoat composition in an amount sufficient to provide curing of the coating. Preferably the acid catalyst is present in the solventborne clearcoat composition in an amount of from about 0.5 weight percent to about 5.0 weight percent, based on total weight nonvolatiles (solids) content, depending upon the particular catalyst selected. Alternatively, the acid catalyst is present in the solventborne clearcoat composition in an amount of from about 1 to about 3 weight percent, depending upon the particular catalyst selected.

The solventborne clearcoat composition comprises at least one organic solvent, and may comprise a mixture of at least two organic solvents. In general, the organic solvent comprises any commonly used organic solvent (or mixture thereof) in which the acid catalyst, the aminoplast crosslinking resin, and the film-forming binder dissolve (or disperse) to a degree that the resulting solution or dispersion can be applied in order to form a coating. Preferably the organic solvent comprises at least one member selected from the group consisting of toluene, xylene, blends of aromatic solvents, butanol and methanol. The organic solvent or solvents are selected for optimum application and characteristics, and to achieve a good appearance. Important considerations comprise viscosity, sprayability, sag tolerance, smoothness, and gloss (i.e. distinctness of image).

The organic solvent should be present in an amount effective to produce a solution or suspension which can be applied to produce an automotive quality coating on a substrate. Preferably, the organic solvent is present in an amount of from 2.0 to 3.5 pounds per gallon, alternatively from 2.0 to 3.0 pounds per gallon and in another embodiment from 2.0 to 3.0 pounds per gallon of the coating composition.

Additional agents, for example surfactants, fillers, stabilizers, wetting agents, dispersing agents, adhesion promoters, UV absorbers, hindered amine light stabilizers, pigments, anti-pop agents, flow control agents, etc. may be incorporated into the coating composition.

When the coating composition according to the invention is used as the clearcoat of a composite color-plus-clear coating, the pigmented basecoat composition may any of a number of types well-known in the art, and does not require explanation in detail herein. Polymers known in the art to be useful in basecoat compositions include acrylics, vinyls, polyurethanes, polycarbonates, polyesters, alkyds, and polysiloxanes. Preferred polymers include acrylics and polyurethanes. In one preferred embodiment of the invention, the basecoat composition also utilizes a carbamate-functional acrylic polymer. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Useful crosslinkable functional groups include hydroxy, epoxy, acid, anhydride, silane, and acetoacetate groups.

Basecoat polymers may be self-crosslinkable, or may require a separate crosslinking agent that is reactive with the functional groups of the polymer. When the polymer comprises hydroxy functional groups, for example, the crosslinking agent may be an aminoplast resin, isocyanate and blocked isocyanates (including isocyanurates), and acid or anhydride functional crosslinking agents.

The two components of the solvent-borne, two-component clearcoat composition are combined just before application to make a coating composition ready for application and curing. Coating compositions can be coated on an article by any of a number of techniques well-known in the art. These include, for example, spray coating, dip coating, roll coating, curtain coating, brush coating and the like. For automotive body panels, spray coating is preferred.

The coating compositions described herein are preferably subjected to conditions so as to cure the coating layers. Although various methods of curing may be used, heat-curing is preferred. Generally, heat curing is effected by exposing the coated article to elevated temperatures provided primarily by radiative heat sources. Curing temperatures will vary depending on the particular blocking groups used in the cross-linking agents, however they generally range from 121° C. to 180° C. Preferably, the curing temperature is greater than 121° C. (250° F.), and preferably greater than 132° C. (270° F.). The curing time will vary depending on the particular components used, and physical parameters such as the thickness of the layers, however, typical curing times range from 15 to 60 minutes, and preferably 15-25 minutes for blocked acid catalyzed systems.

It should be appreciated that the present invention is not limited to the specific embodiments described above, but includes variations, modifications and equivalent embodiments.

### EXAMPLES

### Preparation of Reactive Component A

A mixture of 59.4 parts of Pripol™ saturated fatty acid dimer diol (commercially available from Uniqena), 20.1 parts methyl carbamate, 20.4 parts toluene and 0.09 parts of dibutyl tin oxide are heated to reflux. Once at reflux, the methanol is removed from the reaction mixture and the toluene is allowed to return to the reaction mixture. After 96% of the hydroxy groups are converted to primary carbamate groups, the excess methyl carbamate and toluene are removed by vacuum distillation. A dicarbamate functional reactive component A was obtained.

Clearcoat Compositions (All amounts are in grams)

| | | Invention |
|---|---|---|
| | Comparative Ex. | Ex. (Two |
| Ingredient | (One Component) | Component) |
| Binder¹ | 674.2 | 588.7 |
| Low Imino methylated Melamine² | 127.3 | 247.4 |
| Fumed Silica Dispersion | 144.8 | 158.8 |
| Ultraviolet Light absorber | 25.7 | 28.1 |
| (Tinuvin 400) | | |
| Hindered Amine Light Absorber | 15.3 | 16.8 |
| (Sanduvor 3068) | | |
| Rheology control agent | 2.8 | 3.0 |
| Epoxy acrylic additive³ | 17.9 | 19.6 |
| Blocked phenyl acid phosphate catalyst | 85.8 | — |
| Unblocked phenyl acid phosphate | — | 31.4 |
| catalyst | | |
| Anti-pop additive | 1.8 | 2.0 |
| Flow Additive | 1.9 | 1.3 |
| Solvent (butanol) | 60.5 | 119.5 |

¹Binder is a 71% total solids mixture containing 53.25% of reactive component A and 17.75% of the reaction product of the isocyanurate of IPDI and Hydroxy Propyl Carbamate
²100% solids Resimine 747 methylated melamine
³Epoxy functional acrylic polymer with 300 grams per equivalent epoxy groups

In making the Two Component clearcoat composition of the Invention Example in the above table, the unblocked phenyl acid phosphate catalyst was one component, and the other ingredients were combined in the second component.

### Comparative Study

A Control clearcoat composition, Uregloss R10CG062, a commercially available carbamate-acrylic, melamine cured clearcoat from BASF Corporation, was compared to the Invention Clearcoat Example and the Comparative Clearcoat Example set forth in the table above. The two components of the Invention Clearcoat Example were combined just prior to application. The coatings were evaluated for vertical and horizontal appearance using Autospect OA, where the higher value indicates less microsag and for color strike in, measured by L* at 15°, where the higher value indicates good color travel. A lower value indicates strike-in, meaning that the oligomers in the coating begin to dissolve and affect aluminum flake orientation, resulting in poor color travel.

| | Horizontal | | |
|---|---|---|---|
| | Appearance | Vertical Appearance | |
| | measured by | measured by | 15° L* |
| Coating | Autospect | Autospect | Color Travel |
| Control-over Black | 68.1 | 57.9 | — |
| Basecoat | | | |
| Control-over Silver | — | 55.7 | 140.6 |
| Basecoat | | | |
| Comparative | 55.3 | 41.6 | — |
| Clearcoat Example- | | | |
| (one-component) over | | | |
| Black Basecoat | | | |
| Comparative | — | 35.4 | 131.4 |
| Clearcoat Example- | | | |
| (one-component) over | | | |
| Silver Basecoat | | | |
| Invention Clearcoat | 61.4 | 60.8 | — |
| Example-(two- | | | |
| component) over | | | |
| Black Basecoat | | | |
| Invention Clearcoat | — | 50.4 | 140.7 |
| Example-(two- | | | |
| component) over | | | |
| Silver Basecoat | | | |

The testing reveals an unexpectedly improved appearance for the Invention Clearcoat Example over the one-component Comparative Clearcoat Example.

The invention has been described in detail with reference to preferred embodiments thereof. It should be understood, however, that variations and modifications can be made within the spirit and scope of the invention and of the following claims.

What we claim is:

1. A method of coating a substrate, comprising:
providing a two-component clearcoat composition, comprising (a) an unblocked acid catalyst, (b) a film-forming binder, and (c) an aminoplast crosslinking agent, wherein one of (a)-(c) is in a first component and the remaining two of (a)-(c) are in a second component;
combining the first and second components to make a clearcoat composition just before applying the clearcoat composition to the substrate and then applying the clearcoat composition to the substrate; and
curing the applied clearcoat composition at a temperature above 121° C. (250° F.).

2. A method of coating a substrate according to claim 1, wherein the unblocked acid catalyst is selected from the group consisting of acid anhydrides, acid phosphates, monosulfonic acids, disulfonic acids, alkoxyacids, and combinations thereof.

3. A method of coating a substrate according to claim 1, wherein the unblocked acid catalyst has a pKa of less than 3.5.

4. A method of coating a substrate according to claim 1, wherein the unblocked acid catalyst is selected from the group consisting of para-toluene sulfonic acid, dinonylnaphthalene sulfonic acids, phenyl acid phosphates, alkyl acid phosphates, and combinations thereof.

5. A method of coating a substrate according to claim 1, wherein the aminoplast crosslinking agent comprises a melamine formaldehyde resin.

6. A method of coating a substrate according to claim 5, wherein the melamine formaldehyde crosslinking agent comprises a low imino alkylated melamine formaldehyde resin.

7. A method of coating a substrate according to claim 1, wherein the film-forming binder comprises carbamate groups.

8. A method of coating a substrate according to claim 1, wherein the film-forming binder comprises at least one member selected from the group consisting of star ester oligomers, urethane oligomers and dimer-fatty carbamate compounds.

9. A method of coating a substrate according to claim 1, wherein the substrate comprises an uncured layer of a basecoat composition when the clearcoat composition is applied to the substrate.

10. A method of coating a substrate according to claim 1, wherein the unblocked acid and the film forming binder are in the first component and the aminoplast crosslinking agent is in the second component.

11. A method of coating a substrate, comprising:
providing a two-component clearcoat composition, comprising (a) an unblocked acid catalyst, (b) a film-forming binder, and (c) an aminoplast crosslinking agent, wherein one of (a)-(c) is in a first component and the remaining two of (a)-(c) are in a second component;
combining the first and second components to make a clearcoat composition just before applying the clearcoat composition to the substrate and then applying the clearcoat composition to the substrate; and
curing the applied clearcoat composition at a temperature above 132° C. (270° F.).

12. A method of coating a substrate according to claim 11, wherein the unblocked acid catalyst is selected from the group consisting of acid anhydrides, acid phosphates, monosulfonic acids, disulfonic acids, alkoxyacids, and combinations thereof.

13. A method of coating a substrate according to claim 11, wherein the unblocked acid catalyst has a pKa of less than 3.5.

14. A method of coating a substrate according to claim 11, wherein the unblocked acid catalyst is selected from the group consisting of para-toluene sulfonic acid, dinonylnaphthalene sulfonic acids, phenyl acid phosphates, alkyl acid phosphates, and combinations thereof.

15. A method of coating a substrate according to claim 11, wherein the aminoplast crosslinking agent comprises a melamine formaldehyde resin.

16. A method of coating a substrate according to claim 15, wherein the melamine formaldehyde crosslinking agent comprises a low imino alkylated melamine formaldehyde resin.

17. A method of coating a substrate according to claim 11, wherein the film-forming binder comprises carbamate groups.

18. A method of coating a substrate according to claim 11, wherein the film-forming binder comprises at least one member selected from the group consisting of star ester oligomers, urethane oligomers and dimer-fatty carbamate compounds.

19. A method of coating a substrate according to claim 11, wherein the substrate comprises an uncured layer of a basecoat composition when the clearcoat composition is applied to the substrate.

20. A method of coating a substrate according to claim 11, wherein the unblocked acid and the film forming binder are in the first component and the aminoplast crosslinking agent is in the second component.
